(19) United States
(12) Patent Application Publication
(10) Pub. No.: US 2008/0211334 A1
(43) Pub. Date: Sep. 4, 2008

(54) SPINDLE MOTOR

(76) Inventors: Yasunori TOKUNO, Ehime (JP); Yoshitada Higuchi, Ehime (JP)

Correspondence Address: WENDEROTH, LIND & PONACK L.L.P., 2033 K. STREET, NW, SUITE 800, WASHINGTON, DC, 20006, US

(21) Appl. No.: 12/111,030

(22) Filed: Apr. 28, 2008

Related U.S. Application Data
(63) Continuation-in-part of application No. 11/176,265, filed on Jul. 8, 2005.

(30) Foreign Application Priority Data
Jul. 9, 2004 (JP) 2004-203943

(51) Int. Cl. H02K 7/08

(52) U.S. Cl. 310/90

(57) ABSTRACT

A spindle motor comprises a fixed shaft member, a sleeve, and an annular chucking portion. The fixed shaft member has an annular collar protruding outward from and substantially perpendicular to the outer peripheral surface of said fixed shaft member, and also has a thrust flange provided a specific distance away from said annular collar. The sleeve component is monolithic with a hub component The annular chucking portion is formed to include a surface along an axial direction outside said thrust flange in a diameter direction of said thrust flange. The annular chucking portion is disposed at a position in an axial direction that includes a vertical position of a surface to which said disk is attached.

This is a Rule 1.53(b) Continuation-in-Part of Ser. No. 11/176,265, filed Jul. 8, 2005.

### TECHNICAL FIELD

The present invention relates to a spindle motor that has a hydrodynamic bearing and is used in a magnetic disk device.

### BACKGROUND ART

Spindle motors featuring a hydrodynamic bearing are often used for disk rotary drive motors of magnetic disk devices that record to and reproduce from magnetic disks, in order to reduce noise and increase speed.

With such magnetic disk devices, recording density must be raised in order to increase a recording capacity per magnetic disk and to raise an operating speed. To raise recording density, rotational precision of a spindle motor that rotates the magnetic disk must be increased and the rotation must be stable, so a type of motor that is fixed at both shaft ends, which affords greater rotational stability, is suited to this task. With a motor that is fixed at both shaft ends, these ends of the shaft are fixed to a frame or the like, and a sleeve into which the shaft is inserted rotates. A rotating magnetic disk or the like is attached to this sleeve.

Magnetic disk devices have come to be used in various kinds of mobile devices in recent years. Mobile devices may be subjected to external forces during their use, and it is preferable for a housing not to be deformed by these forces to an extent that an internal magnetic disk or magnetic head is damaged, as this affords greater reliability. One possible way to accomplish this is to support the housing of the device with a shaft such that both ends of the above-mentioned spindle motor shaft are fixed. With a spindle motor used for such mobile devices, a hydrodynamic bearing is generally used. A hydrodynamic bearing needs to have high reliability over a wide range of operating temperatures, but one area that is a particular problem is leakage of lubricating fluid (lubricating oil) of the hydrodynamic bearing, and many different proposals have been aimed at solving this problem.

With a first prior art disclosed in Patent Document 1, a labyrinth seal is provided to a sleeve in order to prevent lubricant leakage. A hydrodynamic bearing is constituted such that a shaft is fixed and a separate hub is attached to a sleeve.

With a second prior art disclosed in Patent Document 2, lubricating oil is sealed and leakage prevented by attaching a seal member to a shaft so as to sandwich a radial bearing between the shaft and a sleeve. A hydrodynamic bearing is constituted such that the shaft is fixed and a separate motor hub is attached to the sleeve.

Patent Document 1: Japanese Patent No. 3,519,457

Patent Document 2: Japanese Laid-Open Patent Application No. 2002-70849

With the first and second prior art disclosed in Patent Documents 1 and 2, assembly precision can be kept high in a direction of a rotational axis during a spindle motor assembly process. Nevertheless, since a sleeve that constitutes a radial bearing and a hub component that holds and fixes a magnetic disk are processed separately, and then these resulting components are combined, it is impossible to avoid a certain amount of off-centeredness (eccentricity) in a radial direction. Consequently, the sleeve vibrates during rotation, or a magnetic disk attachment plane is tilted with respect to the rotational axis. If the sleeve vibrates during rotation, a gap between the shaft and the sleeve fluctuates, so lubricant that fills this gap may leak outside. With a hydrodynamic bearing of the type in which both ends of a shaft are fixed, both ends of a sleeve are open to an atmosphere. Consequently, if a hub component and other rotating bodies do not rotate precisely, a bearing portions will be subjected to greatly varying stress, a gap between the sleeve and shaft forming a radial dynamic bearing will fluctuate, and the lubricant filling this gap will be pushed out and leak outside.

It is an object of the present invention to provide a spindle motor of high reliability, with reduced leakage of lubricating fluid from a hydrodynamic bearing having a sleeve component, a hub component, and a shaft component (the bearing of the spindle motor).

### SUMMARY OF THE INVENTION

The spindle motor according to a first aspect of the present invention comprises a fixed shaft member, a sleeve, and an annular chucking portion. The fixed shaft member is inserted into the sleeve such that a narrow gap is defined between an outer peripheral surface of said fixed shaft member and an inner peripheral surface of said sleeve component. The narrow gap is filled with a lubricating fluid so as to define a hydrodynamic bearing. The fixed shaft member has an annular collar protruding outward from and substantially perpendicular to the outer peripheral surface of said fixed shaft member, and also has a thrust flange provided a specific distance away from said annular collar, said annular collar is one of (i) monolithic with said fixed shaft member, and (ii) press fit onto said fixed shaft member. The sleeve component is monolithic with a hub component that is to fix a disk, and is rotatably supported by said fixed shaft member between said annular collar and said thrust flange such that a narrow gap exists between said sleeve component and said thrust flange. An annular chucking portion is formed to include a surface along an axial direction outside said thrust flange in a diameter direction of said thrust flange. The annular chucking portion is disposed at a position in an axial direction that includes a vertical position of a surface to which said disk is attached. The surface to which said disk is attached is disposed at a position in an axial direction that is not aligned with a position of an annular magnet applying a rotational force to said hub component.

### BRIEF DESCRIPTION OF THE DRAWINGS

FIG. 1 is a cross section of the left half of the spindle motor in Embodiment 1.

FIG. 2 is a cross section of the left half of the spindle motor in Embodiment 2.

FIG. 3 is a cross section of the left half of the spindle motor in Embodiment 3.

FIG. 4 is a cross section of the left half of the spindle motor in Embodiment 4.

FIG. 5 is a cross section of the left half of the spindle motor in other Embodiment.

FIG. 6 is a cross section of the left half of the spindle motor in other Embodiment.

FIG. 7 is a cross section of the left half of the spindle motor in other Embodiment.

### DETAILED DESCRIPTION OF THE PREFERRED EMBODIMENTS

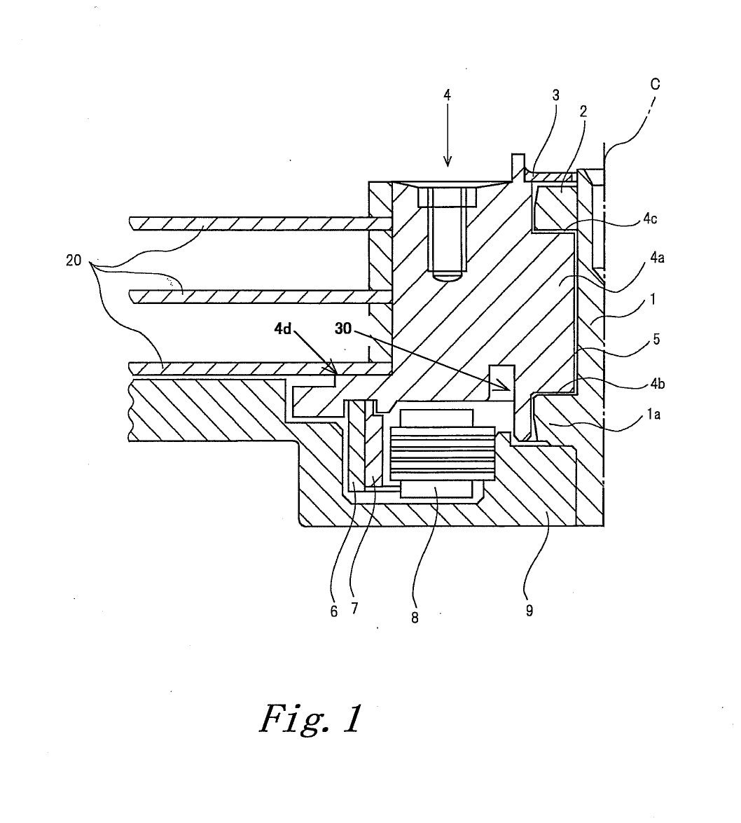

Spindle motors in preferred embodiments of the present invention will now be described through reference to FIGS. 1 to 3.

### Embodiment 1

A spindle motor in Embodiment 1 of the present invention will be described through reference to FIG. 1. FIG. 1 is a cross section of a left half of the spindle motor in Embodiment 1. The right half is not shown since it is symmetrical relative to center line C.

In FIG. 1, a hydrodynamic bearing component used in the spindle motor of Embodiment 1 has a shaft member 1 and a rotating member 4 (hub component) equipped with a sleeve component 4a. The shaft member 1 is fixed at its lower end (in FIG. 1) to a base 9 and has a collar component la that protrudes outward and substantially perpendicularly from an outer peripheral surface near a fixed component. The shaft member 1 is inserted into the cylindrical sleeve component 4a with a narrow gap maintained therebetween. The sleeve component 4a is formed integrally with the rotating member 4. A plurality of magnetic disks 20 are attached to the rotating member 4. An annular thrust flange 2 that is across from the collar component 1a with the sleeve component 4a sandwiched therebetween is fixed by press fitting to the top part of the shaft member 1. An annular seal member 3 that acts as a seal and covers the thrust flange 2 from above is attached. The shaft member 1 is preferably made from a high-strength steel produced, for example, by adding 4 wt % or more manganese, 4 wt % or less nickel, and 12 to 18 wt % chromium to iron. When, for example, the sleeve component 4a is made from a relatively soft material such as aluminum, it is preferable to form a wear-resistant hard coating such as DLC on the inner peripheral surface of the sleeve component 4a, or to perform a surface treatment such as nickel plating, in order to prevent excessive wear when the sleeve component 4a is in contact with the shaft member 1. When the sleeve component 4a is made from aluminum or a copper alloy, it is preferable to form the shaft member 1 from austenite stainless steel, or a high-strength steel having a comparable coefficient of linear expansion. This is effective in terms of reducing variation in the gap between the sleeve component 4a and the shaft member 1, and preventing the leakage of lubricating fluid, even if the usage temperature changes.

A narrow gap 5 is formed between the sleeve component 4a and the shaft member 1. Also, narrow gaps 4c and 4b are formed between the sleeve component 4a and the thrust flange 2 and between the sleeve component 4a and the collar component 1a, respectively. The gaps 5, 4c, and 4b are filled with a lubricating fluid (lubricant) that serves as a working fluid. As a result, the sleeve component 4a is able to rotate around the fixed shaft member 1. The seal member 3 is used to prevent the lubricant from leaking from the upper end of the shaft member 1. A spiral or herringbone pattern radial dynamic pressure generating groove (not shown), which is well known in this field of art, is formed by rolling, which is a deformation processing known in the past, or by electrochemical machining, etching, or the like around the inner peripheral surface of the sleeve component 4a, thereby constituting a radial bearing. A thrust dynamic pressure generating groove (not shown) is also formed in a spiral or herringbone pattern in at least one of the opposing faces of the thrust flange 2 and the sleeve component 4a, and in at least one of the opposing faces of the collar component 1a and the sleeve component 4a, thereby constituting a thrust bearing.

A back yoke 6 made of a magnetic material is fixed to the rotating member 4, and a cylindrical magnet 7 is disposed on the inner peripheral surface of this yoke. A stator core 8 comprising a drive coil wound around the magnet 7 is disposed on the inner peripheral surface of the magnet 7 with a specific gap therebetween. The stator core 8 is fixed to the base 9 and constitutes a rotational drive component. The rotational drive component in FIG. 1 is such that the stator core 8 is disposed in the inner peripheral side of the magnet 7, but the magnet 7 may be disposed around the outer periphery of the back yoke 6, and the stator core 8 disposed on the outer peripheral side of the magnet 7 with a specific gap therebetween.

When electric power is supplied to the coil of the stator core 8, the magnet 7 receives a rotational drive force, and the rotating member 4, including the sleeve component 4a, rotates. The rotation of the sleeve component 4a results in the formation of a radial hydrodynamic bearing between the shaft member 1 and the sleeve component 4a. Also, a thrust hydrodynamic bearing is formed in the space 4b between the sleeve component 4a and the collar component 1a, and in the space 4c between the sleeve component 4a and the thrust flange 2, and the sleeve component 4a rotates without being in contact with the shaft member 1, the collar component 1a, or the thrust flange 2.

With Embodiment 1, since the rotating member 4 and the sleeve component 4a, which are rotating bodies, are constituted integrally and form a single component, the machining precision is higher, and eccentricity from the rotational axis C at the rotational center of the rotating member 4 can be minimized. Accordingly, there will be no vibration between the sleeve component 4a and the shaft component la during rotation, nor will the sleeve component 4a become tilted with respect to the shaft component 1a, and the rotating member 4 will rotate stably around the shaft member 1. This stable rotation allows the gap between the shaft member 1 and the sleeve component 4a to be kept constant during rotation, with no fluctuation. This means that the lubricating fluid filling the gap between the shaft member 1 and the sleeve component 4a of the radial hydrodynamic bearing will not be pushed out of this gap and leak to the outside.

### Embodiment 2

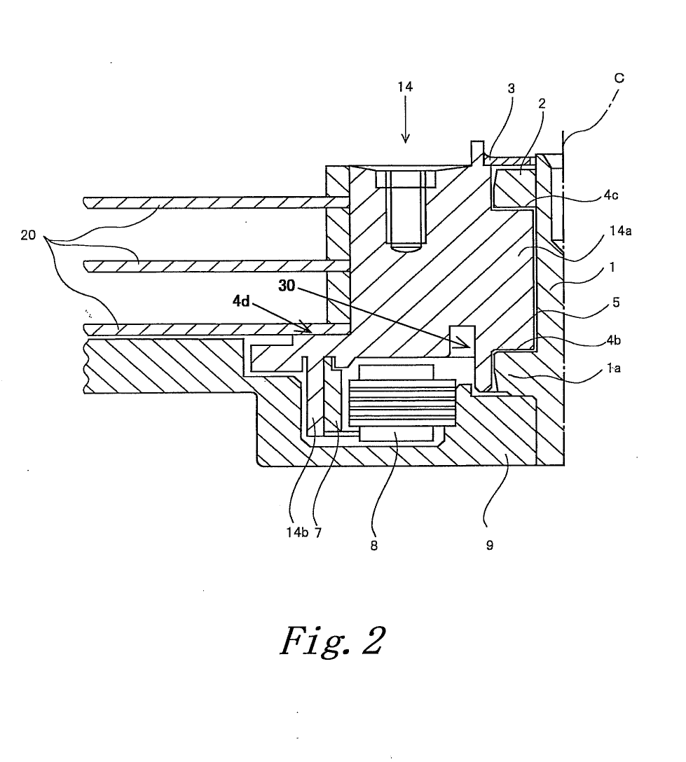

The spindle motor of Embodiment 2 of the present invention will be described through reference to FIG. 2. FIG. 2 is a cross section of the left half of the spindle motor in Embodiment 2. The right half is not shown since it is symmetrical to the center line C.

In FIG. 2, the constitution of the shaft member 1, the thrust flange 2, the seal member 3, the stator core 8, and the base 9 is the same as that in Embodiment 1 shown in FIG. 1, and these components operate in the same manner and will therefore not be described again.

With Embodiment 2, only the constitution of a rotating member 14 (hub component) is different from that of the rotating member 4 in FIG. 1. The rotating member 14 has an integrally constituted sleeve component 14a and back yoke 14b. The sleeve component 14a is constituted the same as the sleeve component 4a in FIG. 1, and operates the same.

The back yoke 6 in Embodiment 1 shown in FIG. 1 is attached to the rotating member 4 as a separate component, so depending on how it is attached, there may be deviation (eccentricity) between the center axis of the rotating member 4 and the center axis of the back yoke 6. Accordingly, the attachment step entails high-precision work, which means that attachment takes longer and is more expensive.

The hydrodynamic bearing in Embodiment 2 is characterized in that the back yoke 14b is formed integrally with the rotating member 14, so the machining precision of the back yoke 14b can be kept high. Since the back yoke 14b must be made of a magnetic material, the rotating member 14 that is constituted integrally with the back yoke 14b is made from a magnetic material such as JIS SUS 420. This limits the materials that can be used for the rotating member 14, but also reduces assembly cost, so the total cost is lower. The material of the shaft member 1 may also be SUS 420 or the like, but is preferably a high-strength steel. With the spindle motor in Embodiment 2, since the sleeve component 14a, the rotating member 14, and the back yoke 14b are constituted integrally, deviation (eccentricity) between these can be kept extremely small. This means that the sleeve component 14a will rotate extremely stably around the shaft member 1. This stable rotation allows the gap between the sleeve component 14a and the shaft member 1 to be held constant, so there is almost no leakage of lubricating fluid to the outside. Furthermore, the magnet 7 may be disposed on the outer peripheral side of the back yoke 14b, and the stator core 8 disposed on the outer peripheral side of the magnet 7.

### Embodiment 3

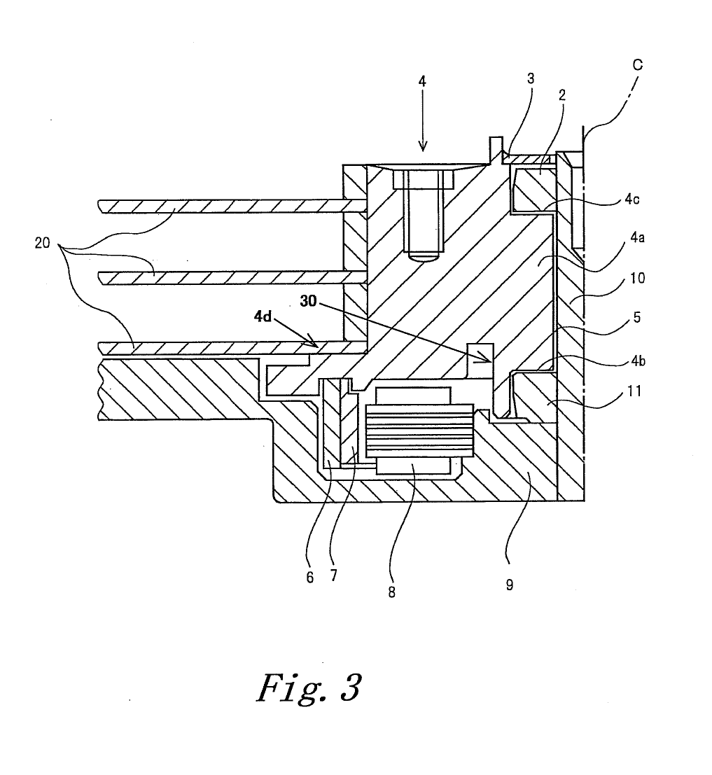

The spindle motor in Embodiment 3 of the present invention will be described through reference to FIG. 3. FIG. 3 is a cross section of the left half of the spindle motor in Embodiment 3. The right half is not shown since it is symmetrical to the center line C.

In FIG. 3, the constitution of the thrust flange 2, the seal member 3, the rotating member 4 (hub component) and its sleeve component 4a, the back yoke 6, the magnet 7, the stator core 8, and the base 9 is the same as that in Embodiment 1 shown in FIG. 1, and these components operate in the same manner and will therefore not be described again.

With Embodiment 3, the constitution of a shaft member 10 and a thrust flange 11 is different from the constitution in Embodiment 1. The rod-shaped shaft 10 is fixed at its lower end (in the drawing) to the base 9. The thrust flange 11 (first annular member) is fixed to the shaft 10 near the base 9. The sleeve component 4a is provided between the thrust flange 11 and the thrust flange 2 (second annular member) fixed to the upper end of the shaft 10. A thrust dynamic pressure generation groove (not shown) is provided to at least one of the opposing faces of the sleeve component 4a and the thrust flange 11.

With Embodiment 3, since the annular thrust flange 11 is attached to the rod-shaped shaft 10, the structure of the shaft 10 is simpler than that of the shaft member 1 in Embodiment 1, which affords a cost reduction for the shaft member. Again with the spindle motor in Embodiment 3, just as with that in Embodiment 1, the sleeve component 4a is constituted integrally with the rotating member 4, so the sleeve component 4a rotates stably around the shaft member 1. Therefore, the gap between the sleeve component 4a and the shaft member 1 during rotation is held stable, so there is no danger that the lubricating fluid will leak to the outside.

Several embodiments were selected and described in order to describe the present invention, but a person skilled in the art will be capable of performing various modifications and improvements without deviating from the scope of the invention as defined in the appended claims. Also, the embodiments of the present invention given above are given for the purpose of illustration, and not for the purpose of limiting the invention as defined in the claims and equivalents thereof.

### Embodiment 4

The spindle motor in Embodiment 4 of the present invention will be described through reference to FIGS. 1 to 3 and 4.

That is, miniaturization of a hub and a sleeve as well as improvement in precision are both required in accordance with reduction in size and increase in capacity of a recent motor. Herein, there is a possibility that it is difficult to keep a circularity of the sleeve and ensure precision of a disk attachment surface due to an excessive fastening strength upon combination of the hub with the sleeve.

As shown in FIGS. 1 to 3 and 4, the spindle motor in this embodiment is of a so-called outer rotor type. Herein, a rotating member 4 has a hub and a sleeve (sleeve component 4a) formed integrally with each other. In the rotating member 4, a surface 4d to which a magnetic disk 20 is attached is disposed at a position overlapping with a chucking portion 30 having a substantially annular chucking surface in an axial direction.

Herein, the disk attachment surface 4d requires machined finish at a precision on the order of submicron. Therefore, when a workpiece becomes large in size like the rotating member 4 having the hub and the sleeve formed integrally with each other, it is necessary to prevent whirling of a shaft in the machining. In the machining, preferably, the chucking portion 30 is formed such that a surface including the disk attachment surface 4d, which requires precision, at an axial height intersects an outer peripheral surface.

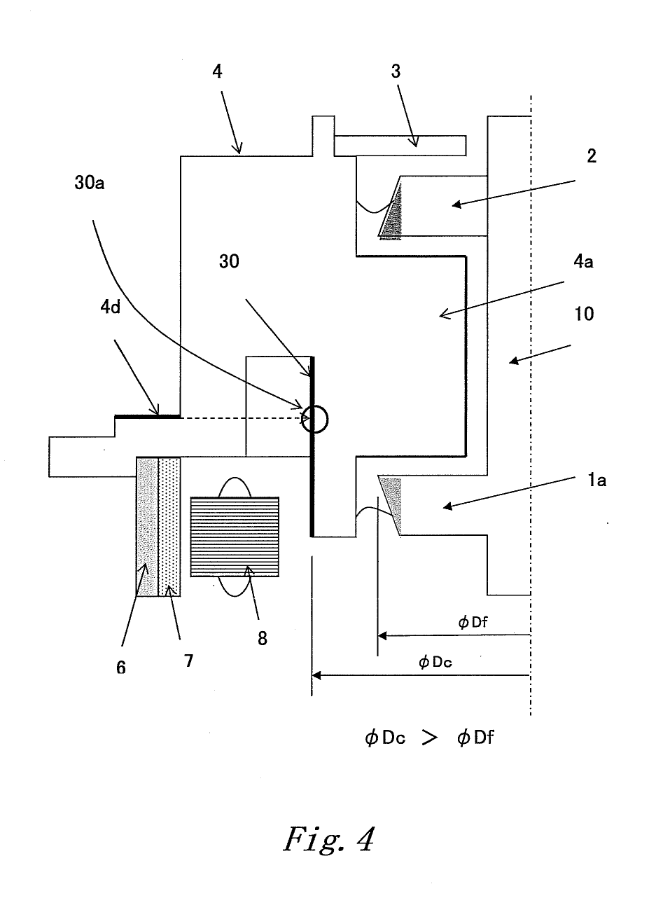

The chucking portion 30 corresponds to a substantially annular outer peripheral surface disposed outward with respect to a collar component 1a in the rotating member 4. As shown in FIG. 4, a chucking diameter φDc of the chucking portion 30 is larger than a flange diameter φDf of the collar component 1a. Herein, the chucking portion 30 corresponds to a portion of a main shaft attached to a machine tool at the time of cutting the rotating member 4. For example, the chucking portion 30 corresponds to a portion attached and fixed to a lathe chuck in a lathe.

In the rotating member 4, moreover, a magnet 7 is disposed at a position not overlapping with the disk attachment surface 4d in the axial direction. As described above, the magnet 7 is disposed while being displaced in the axial direction so as not to overlap with the disk attachment surface 4d, thereby preventing the precision of the disk attachment surface 4d from being degraded due to a stress generated upon assembly of the spindle motor.

In this embodiment, as described above, the rotating member 4 used herein has a configuration that the hub and the sleeve are formed integrally with each other, and the disk attachment surface 4d overlaps with the chucking portion 30 in the axial direction.

Thus, it is possible to eliminate an influence such as deviation at the time of attachment between the hub and the sleeve and to improve accuracy of finishing of the disk attachment surface 4d, thereby improving the precision of the disk attachment surface 4d.

In addition, the magnet 7 described above is disposed while being displaced in the axial direction so as not to overlap with the disk attachment surface 4d, thereby preventing the precision of the disk attachment surface 4d from being degraded due to a stress generated upon assembly of the spindle motor.

As a result, the precision of the disk attachment surface 4d can be improved remarkably in comparison with the conventional art.

### Other Embodiments

(A)

In the foregoing embodiments, as an example, the rotating member 4 is chucked preferably so as to include the axial height position equal to the disk attachment surface 4d in the axial direction; however, the present invention is not limited thereto.

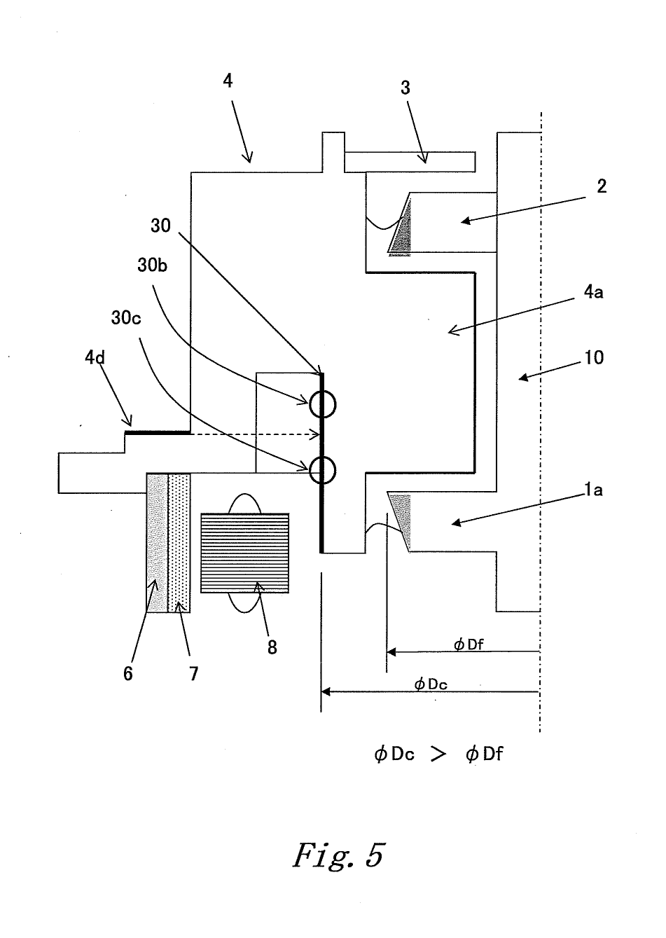

As shown in FIG. 5, for example, chucking points 30b and 30c are preferably disposed evenly so as to sandwich the axial position equal to the disk attachment surface 4d in the chucking portion 30.

Also in this case, the chucking portion 30 is chucked evenly with respect to the disk attachment surface 4d, thereby improving the precision of the disk attachment surface 4d.

(B)

In the foregoing embodiments, as an example, the spindle motor of a so-called outer rotor type is used, and the magnet 7 fixed to the rotating member 4 is disposed adjacent to the outer peripheral side of the stator core 8; however, the present invention is not limited thereto.

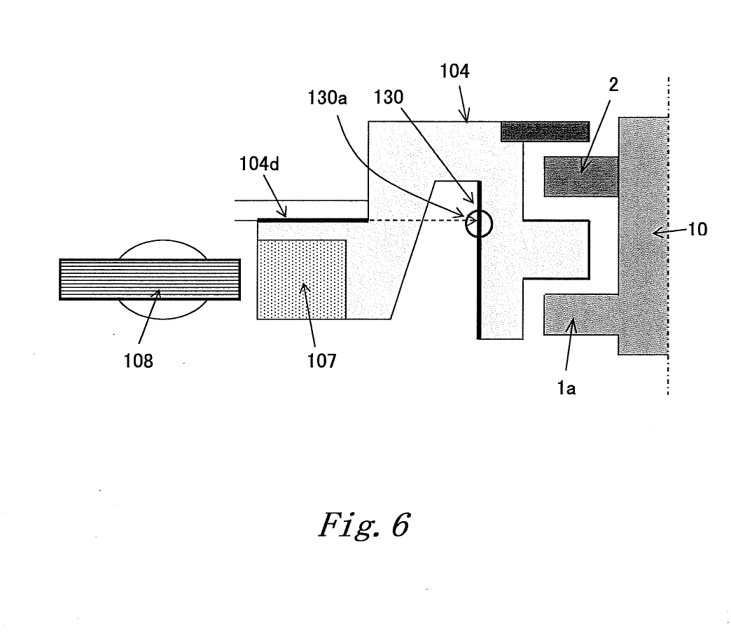

As shown in FIG. 6, for example, the present invention is applicable to a spindle motor of a so-called inner rotor type in which a magnet 107 fixed to a rotating member 104 is disposed adjacent to an inner peripheral side of a stator core 108.

In this configuration, a chucking point 130a is provided at a position axially equal to a disk attachment surface 104d in a substantially annular chucking portion 130 formed as a part of the rotating member 104.

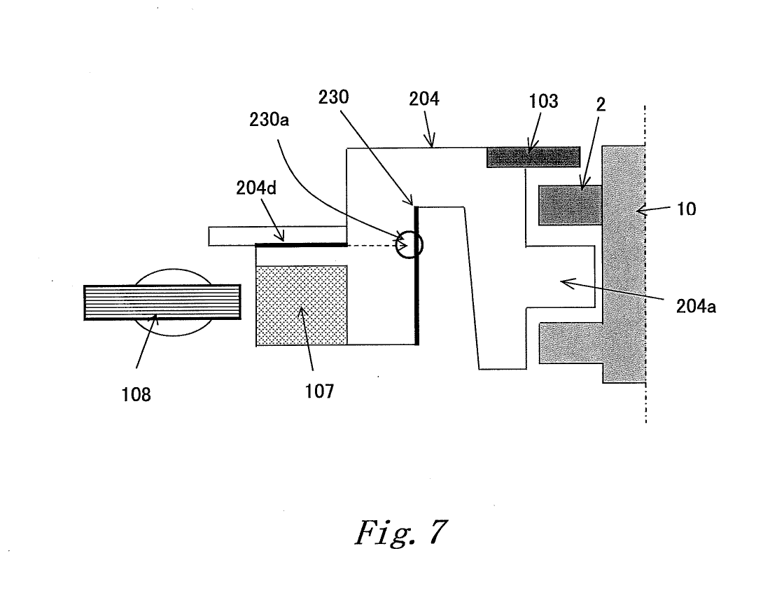

Also, as shown FIG. 7, the rotating member 204 is chucked preferably so as to include the axial height position equal to the disk attachment surface 204d in the axial direction.

Thus, this configuration can achieve an advantage similar to that in the foregoing embodiment.

Along with the miniaturization of the spindle motor, the chucking portion 130 is not disposed at the outer periphery of the collar component la, but may be disposed at the outer periphery of the thrust flange 2.

(C)

In the foregoing embodiments, as an example, the rotating member 104 is made of a magnetic material (e.g., DHS 1 corresponding to stainless steel), and a part thereof serves as the back yoke of the magnet 107; however, the present invention is not limited thereto.

For example, the back yoke may be a separate member to be attached to the rotating member.

However, the configuration described in the foregoing embodiment is more preferred in terms of such a point that the formation of the back yoke as a part of the rotating member having the configuration that hub and the sleeve are formed integrally with each other allows improvement in attachment accuracy of the magnet.

(D)

In the foregoing embodiments, the recording medium to be mounted to the spindle motor is a magnetic disk; however, the present invention is not limited thereto.

The present invention is applicable to any types of disk as long as it is a recording medium.

In the foregoing embodiments, as an example, the chucking portion 30 is chucked from an outer peripheral surface side of the rotating member 4; however, the present invention is not limited thereto.

As shown in FIG. 7, for example, the chucking portion 230 may be chucked from an inner peripheral side of the rotating member 204.

In this configuration, a tiny deforming of the radial bearing and the thrust bearing is prevented when the chucking portion is chucked, thereby improving the reliability of the bearing.

### INDUSTRIAL APPLICABILITY

The present invention can be utilized in a spindle motor that requires a high-precision hydrodynamic bearing.

1. A spindle motor comprising:
a fixed shaft member,
a sleeve component into which said fixed shaft member is inserted such that a narrow gap is defined between an outer peripheral surface of said fixed shaft member and an inner peripheral surface of said sleeve component, said narrow gap being filled with a lubricating fluid so as to define a hydrodynamic bearing, and
wherein said fixed shaft member has an annular collar protruding outward from and substantially perpendicular to the outer peripheral surface of said fixed shaft member, and also has a thrust flange provided a specific distance away from said annular collar, said annular collar being one of
(i) monolithic with said fixed shaft member, and
(ii) press fit onto said fixed shaft member,
wherein said sleeve component is monolithic with a hub component that is to fix a disk, and is rotatably supported by said fixed shaft member between said annular collar and said thrust flange such that a narrow gap exists between said sleeve component and said thrust flange, and
the sleeve component further comprising an annular chucking portion, the annular chucking portion being formed to include a surface along an axial direction outside said thrust flange in a diameter direction of said thrust flange, the annular chucking portion being disposed at a position in an axial direction that includes a vertical position of a surface to which said disk is attached, and
said surface to which said disk is attached is disposed at a position in an axial direction that is not aligned with a position of an annular magnet applying an rotational force to said hub component.

2. A spindle motor comprising:
A fixed shaft member;
A sleeve component into which said fixed shaft member is inserted such that a narrow gap is defined between an outer peripheral surface of said fixed shaft member and an inner peripheral surface of said sleeve component said narrow gap being filled with a lubricating fluid so as to define a hydrodynamic bearing; and
wherein said fixed shaft member has an annular collar protruding outward from and substantially perpendicular to the outer peripheral surface of said fixed shaft member, and also has a thrust flange provided a specific distance away from said annular collar, said annular collar being one of
(i) monolithic with said fixed shaft member, and
(ii) press fit onto said fixed shaft member,
wherein said sleeve component is monolithic with a hub component that is to fix a disk, and is rotatably supported by said fixed shaft member between said annular collar and said thrust flange such that a narrow gap exists between said sleeve component and said thrust flange, and
the sleeve component further comprising an annular chucking portion, the annular chucking portion being formed to include a surface along an axial direction outside said annular collar in a diameter direction of said annular collar, the annular chucking portion being disposed at a position in an axial direction that includes a vertical position of a surface to which said disk is attached, and
said surface to which said disk is attached is disposed at a position in an axial direction that is not aligned with a position of an annular magnet applying an rotational force to said hub component.

3. The spindle motor according to claim 1, wherein:
a back yoke for attaching the annular magnet is monolithic with the hub component.

4. The spindle motor according to claim 2, wherein:
a back yoke for attaching the annular magnet is monolithic with the hub component.
